(19) United States
(12) Patent Application Publication
(10) Pub. No.: US 2019/0392512 A1
(43) Pub. Date: Dec. 26, 2019

(54) ELECTRONIC NEGOTIATION SYSTEM

(71) Applicant: Bid Ops Inc., San Francisco, CA (US)

(72) Inventors: Edmund Adam Zagorin, San Francisco, CA (US); Christian Eric Kruttschnitt Ries, Dana Point, CA (US); Andrew Christopher Jones, Atlanta, GA (US)

(73) Assignee: Bid Ops Inc.

(21) Appl. No.: 16/451,651

(22) Filed: Jun. 25, 2019

Related U.S. Application Data
(60) Provisional application No. 62/689,438, filed on Jun. 25, 2018.
(60) Provisional application No. 62/691,768, filed on Jun. 29, 2018.

(51) Int. Cl. G06Q 30/08; G06Q 50/18

(52) U.S. Cl. CPC G06Q 30/08; G06Q 50/188

(57) ABSTRACT

An electronic auction tool for generating quotes and rankings associated with a seller is described herein. In response to receiving a request for a product from a buyer, one or more sellers may choose to participate in a negotiation for fulfilling the request. The system may receive a request for a product and/or service from a buyer that stipulates a number of bidding rounds during which the seller(s) may submit a limited number of quotes during a limited period of time. Additionally, a rank associated with the seller(s) may be generated based on historical transaction data. Further, a price-matching quote round may be conducted, during which the seller may have an opportunity to modify the submitted quote to match the quote with a lowest bid submitted by the other participating sellers. By using the structured and automated techniques described herein, the incentive to submit last minute quotes may be eliminated, and system resources of the electronic auction tool may avoid being inundated with last minute requests by sellers during a bidding round and/or the negotiation being indefinitely prolonged due to the arrival of new quote offers by one or more competing sellers. Further, an accurate and dynamic seller ranking may be determined in real-time without burdening system resources with analyzing unnecessary and biased data points.

### CROSS REFERENCE TO RELATED APPLICATIONS

This application claims priority to Provisional Application No. 62/689,438 filed Jun. 25, 2018, entitled “An Electronic Auction Computer System Using a Structured Multi-Round, Multi-Vendor Digital Communication Network to Reduce Processing Power,” and Provisional Application No. 62/691,768 filed Jun. 29, 2018, entitled “System Using Eigenvectors to Automate Vendor Portfolio Management and Vendor Preference Ranking Over Digital Communication Networks to Reduce Processing Power,” which are incorporated herein by reference.

### BACKGROUND

Conventional auction systems allow a buyer to request a product (e.g., goods and/or services) on a platform and sellers may present a bid for providing the product. In this instance, once the bidding period is over, the seller may choose the bid that best suits their needs. For example, the buyer may award the contract to the winning bid, such as the lowest cost bid, the quickest delivery period, and the like. Typically, the seller may enter a bid at any point before the bidding period is over, which may result in sellers entering bids at the very end of the auction to ensure they are the lowest bid. Further, the bids may be presented to the buyer with no indications of the seller's performance, reputation, and the like. This may result in the buyer selecting a bid based on price alone. Thus, the conventional auction systems described herein may lead to an efficient use of system resources and a less optimized bid selection process.

### BRIEF DESCRIPTION OF THE DRAWINGS

Features of the present disclosure, its nature and various advantages, may be more apparent upon consideration of the following detailed description, taken in conjunction with the accompanying drawings.

FIG. 1 illustrates an example environment for an electronic negotiation system according to some implementations.

FIGS. 2A and 2B illustrates an example round of an electronic negotiation according to some implementations.

FIG. 3 illustrates a flow diagram of an example process for electronic negotiation according to some implementations.

FIG. 4 illustrates another flow diagram of an example process for electronic negotiation according to some implementations.

FIG. 5 illustrates an example server computing device that may be used for electronic negotiations according to some implementations.

In the figures, the left-most digit(s) of a reference number identifies the figure in which the reference number first appears. The use of the same reference numbers in different figures indicates similar or identical items or features. The drawings are not to scale.

### DETAILED DESCRIPTION

Techniques described herein are directed to, in part, an electronic negotiation system. In particular, the electronic negotiation system includes a tool for generating quote bids for providing a product to a buyer and/or for generating a ranking of the prospective sellers submitting the quote bids. The system allows quotes, or bids, to be generated on behalf of a seller (e.g., a service provider, vendor, or supplier) in response to a buyer (e.g., the party requesting the service or goods) request for a product provided by the seller or service provider. The system also allows a ranking, or scoring, to be generated with respect to a seller or service provider to be provided to the buyer along with the submitted quotes of the seller.

To provide an example, a buyer may request a product, such as a good or service, via a contract negotiation or auction platform. The request may include a number of bidding rounds that the buyer would like conducted, a number of quotes that may be submitted by the seller during each round, and a time period that each round will last. In response, the request information may be provided to one or more sellers capable of fulfilling the request. In examples, should the seller decide to make a bid for fulfilling the request, the system may utilize data, such as buyer-provided data (e.g., buyer inputs, stored buyer data, etc.), market data, third-party data, historical data, and the like, to generate one or more quotes on behalf of the seller throughout the bidding process, and generated by the buyer's platform, for fulfilling the request. For example, the initial quote generated by the buyer's platform, referred to herein as a should-cost value or should-cost quote (e.g., the cost that the providing the product should cost the seller), may be generated on behalf of the seller and may be dynamically adjusted throughout the negotiation process based on characteristics of the negotiation (e.g., the dollar amount of the request/product, the number of seller counterparties, the relative distribution of dollars in specific line items and the number of equivalently competitive sellers, etc.) to generate additional quotes. It should be understood that, unlike traditional systems, the should cost quote or bid is generated by the buyer system based on the buyer's criteria and provided as a suggested or recommended quote to the seller.

Upon receiving each quote, the seller has a predetermined period of time to choose to accept, modify, or deny the estimate and submit a finalized quote for acceptance by the buyer. Alternatively, or in addition, the seller may provide the system authorization to accept the bid on their behalf. The process may continue until the number of bidding rounds indicated by the request has been fulfilled. Once the bidding rounds have been satisfied, the final quotes of each seller may be provided to the buyer at the conclusion of the auction. Based on the final quotes, the buyer may select a seller to provide the product.

Further, the negotiation system may generate a rank and/or score associated with each seller participating in the negotiation. For example, the system may generate a ranking of a seller, with respect to the other participating sellers, based on the quotes being submitted by the seller during each bidding round, seller information, and/or buyer preferences. For example, if the buyer preferences indicate that the buyer prefers sellers that have been operating for a certain number of years, the sellers with this characteristic may rank higher thank sellers that have not been operating for the specified number of years. Alternatively, or in addition, the system may utilize historical transaction data to generate a modified rank and/or score for the seller. In examples, the rank and/or score may take into account a number of bids awarded to the seller during previous transactions, a financial obligation associated with the transaction, and/or a reputation of the buyer. Utilizing this information, the system may modify the initial ranking of the seller to reflect the additional transactional information and the modified ranking may be provided to the seller along with the quotes at the conclusion of the auction. In this way, the buyer may utilize the modified ranking to choose a seller that more closely fits the buyer's needs.

As is known, conventional auction systems are configured to allow a buyer to make a request for a product and allow the seller to provide bids in hopes of being selected. For example, in response to the buyer's request, in the conventional auction system, the seller may utilize internal data (e.g., data known to the seller), such as current seller's inventory, seller's supplier costs, and the like, to formulate a bid. The bid may represent the cost at which that the seller is willing or desires to provide the product or services. However, utilizing only internal seller data may lead to inaccurate bids (e.g., bidding too high or too low). Alternatively, or in addition, the buyer may set an initial cost threshold associated with the product. That is, the buyer may stipulate, along with the request, a cost that the seller may not exceed in purchasing the product. As a result of providing an initial cost threshold, the bids provided by the sellers may be skewed to accommodate the boundaries provided by the buyer. The techniques for generating automated quotes described herein, however, help to formulate more accurate and efficient cost estimations for fulfilling the buyer's request for products or services.

Further, the techniques described herein help, in some cases, to prevent inefficient resource allocations and increase the processing capacity of the system components. For example, in conventional auction platforms, the seller may be motivated to provide bids at the end of the auction in order to provide the lowest bid and be selected by the buyer, often called bid sniping. When used, the bid sniping technique ensures that, in the conventional auction system, the seller providing the last bid wins, as the seller's competitors do not have time to re-bid. The practical result, in the conventional auction system, is that all bids by all sellers are held until the period of time to enter a bid is ending. This results in the conventional auction system implementing a large number of processing resources that are used only during the final moments of the auction, resulting in massive inefficacies and large spikes in bandwidth and computer resource consumption. In some cases, the conventional auction systems are unable to handle the volume of bids and, thus, some bids are lost, including a potential winning bid. To prevent bid sniping, many online conventional auction systems implement time extensions in response to each new winning bid being received, thereby allowing the seller's competitors additional time to re-bid, thereby preventing loss of a winning bid due to lack of computer resources. However, while the implementation of time extensions in conventional systems may prevent loss of winning bids and/or increases in the overall sale price, the large spikes in bandwidth and computer resource consumption are increased as the spike occurs at the expiration of each extended period of time, resulting in the conventional auction system that consumes far more computing resources and bandwidth than necessary.

Additionally, as is known, conventional negotiation systems may generate a ranking associated with prospective sellers to assist the buyer in selecting a seller that best suits their business needs. For example, conventional systems may generate rankings based on data points from a variety of sources, such as employees of the company, sales teams, etc. The data points may be related to various aspects of the seller, such as prices, experience, quality, environmental impact, and the like. However, analyzing data from multiple, human contributors may lead to excess and/or unnecessary data points and skewed results due to discrepancies between individual contributors and automated aspects of the process. Further, receiving and analyzing these large data inputs at scale may place a substantial burden on system resources. Still further, once the analysis takes place, the resulting data may only be utilized in the current negotiation and not aggregated and/or adjusted on a continual basis.

The techniques and systems described herein are designed to prevent the large spikes in bandwidth and computer resources caused by the conventional auction systems. For example, the system discussed herein ensures that the seller has been provided with an optimized quote prior to submission of the seller's bid. In addition, the seller may only view their generated quote provided during each bidding round (e.g., each seller is provided by the system a personalized or non-personalized quote). As a result, by generating an optimized quote on behalf of the seller, and preventing the seller from viewing competing quotes, the incentive to place a last-minute bid in order to provide the lowest bid is decreased and/or removed. Further, the system discussed herein ensures that the seller is aware that they may only submit a set number of quotes during each round, as stipulated by the buyer. For example, the seller may only be allowed to submit one quote per round. In this way, the seller is not incentivized to submit a last-minute bid as they cannot submit additional bids based on competing bids from other sellers. In contrast, the seller is motivated to generate the best possible quote, based only on their own information and/or the system generated quote, for submission at any point during the bidding round. In this way, the system is less likely to receive an inundation of bids, thereby increasing the efficiency and resource allocation of the processing components (e.g., fewer recourse may be implemented as the processing period is expanded).

In addition, the techniques and systems described herein are designed to prevent the processing of large, and unnecessary, quantities of information to generate an accurate ranking for each seller and/or utilize this ranking to determine generated quotes. In particular, the techniques for generating rankings described herein, help to efficiently formulate more accurate rankings to help the buyer select a seller that will fulfill the seller's request for products or services according to their preferences and/or needs. For example, by using eigenvectors to relate the historical transaction data (e.g., aggregate purchasing decisions of buyers, characteristics of the purchase, etc.) within an enterprise to assign a rank to vendors in a relational database, the need to process unnecessary quantities of evaluation data is eliminated and less computer resources are required. Further, a real-time ranking may be generated that more accurately reflects the preferences of buyers and, therefore, allows the system to more accurately determine quotes for each seller. As a result, buyers may have the necessary information to choose a seller that more closely fits their needs.

In examples described below, the system may receive a request for a product from a first user, such as a buyer. The request may include information regarding the requested product (e.g., the good and/or service, each item of the good and/or service, etc.), buyer preferences (e.g., value preferences such as a preferred seller, level of expertise, product specifications, etc.), negotiation preferences (e.g., a number of bidding rounds, a time period for each bidding round, a number of quotes that may be accepted during each bidding round, etc.), and the like. The buyer information may be utilized by the system to dictate negotiation specifications, generate quotes on behalf of the seller, rank the seller with respect to other sellers, and/or a score associated with each seller (e.g., indicating a likelihood that a seller will win).

The request may be provided to one or more additional users, such as sellers, capable of providing the requested product. For example, an indication of the request may be displayed to the user via a user interface associated with the negotiation platform. In some examples, the indication may provide an option to view the request and/or provide input regarding a desire to fulfill the request. For example, one or more sellers may view the request, and/or additional information provided by the seller, and may provide input indicating that the seller would like to fulfill the request (e.g., provide the requested good and/or service). At this time, or prior to this, the one or more sellers may provide information to the system regarding the seller and/or the seller's company (e.g., years in operation, number of employees, etc.), products provided, and the like. The seller information, along with historical transaction data, may likewise be utilized by the system to dictate negotiation specifications, generate quotes on behalf of the seller, rank the seller with respect to other sellers, and/or generating a score associated with each seller (e.g., a score indicating a likelihood that the seller will win).

In examples, the system may determine a quote on behalf of individual sellers that indicates an optimized cost for fulfilling an item of the good/service. For example, the system access data to aid in generating the quote(s) on behalf of the seller(s) that have provided input indicating a desire to fulfill the buyer request. For example, the system may access the buyer data, the seller data, historical data (e.g., historical transaction data, pricing or product data, etc.), and/or one or more third-party resources such as market data, commodity data, and the like. The system may utilize this accessed data to generate a quote associated with each of the sellers. The quote may represent an optimized cost to the seller to fulfill the buyer request (e.g., a cost to the seller to provide the good and/or service to the buyer). Alternatively, or in addition, the seller may provide a quote that the seller has generated.

In examples, a ranking may also be generated in association with the seller. For example, based on the quote, historical transaction data (e.g., a percentage of transactions for which the seller was chosen), and/or transaction characteristics (e.g., the experience level of the buyer, the financial obligation of the transaction, etc.), a ranking may be generated. For example, the system may utilize the request information, buyer information, seller information, and/or third-party information to rank each seller with respect to the other participating sellers. For instance, if the buyer information stipulates a preference for larger companies, a smaller company seller may be ranked lower with respect to larger sellers. In examples, based on the historical transaction data and/or the transaction characteristics, the initial ranking may be adjusted. For example, the system may dynamically generate a real-time ranking for the seller based on the historical transaction and this ranking may be used to adjust the ranking based on the current transaction data. The dynamic ranking may be updated with each transaction and may be stored for future use by the system. The ranking may be provided to the seller along with the quote(s) during each bidding round. In some cases, each seller may only receive the sellers current rank (e.g., tenth out of one hundred sellers). In addition, the ranking may affect future quotes and/or rankings that are generated for each seller. For example, if a seller is ranked lower, the quote generated may be lower as the seller may be deemed less desirable (e.g., may require a lower quote to offset other parameters causing the lower ranking).

In some examples, once the quote has been generated on behalf of a seller, the quote may be provided to the seller for review. For example, rather than providing a current winning bid as in a conventional auction system, the contract negotiation system discussed herein generates and provides a quote to each seller and the option may be given to the seller to at least one of accept, modify, or decline the quote and/or give the system authorization to accept the quote on their behalf without further input. Thus, each seller is unaware of both the quote and the bids of the other sellers.

Upon receiving the quote, each seller may accept, modify, or decline the quote within the amount of time associated with the current bidding round as determined by the seller. For example, the seller may wish to accept the quote as-is and provide the quote without modification to the buyer for acceptance. Alternatively, the seller may wish to modify the quote based on one or more factors. For example, the seller may wish to increase or decrease the generated quote before providing to the buyer (e.g., the seller may be unable to perform the services or provide the product at the price indicate by the quote). Lastly, the seller may wish to decline the quote. Independent of the actions of the seller with respect to the quote, the accepted, modified, or decline quote may be provided to the buyer. Alternatively, or in addition, the seller may authorize the system to automatically accept the quote on their behalf without further input required. The seller may perform any of the above operations before the time period associated with the bidding round has expired. For example, as described above, the buyer may provide, with the request, a time that each bidding round may last. As such, the seller must provide the feedback data within the period of time stipulated by the buyer.

In examples, based on the feedback data, the system may determine a final quote. For example, if the seller has chosen to modify the quote, the system may modify the quote to reflect the modifications indicated by the feedback data. In particular, the system may adjust the quote up or down.

In further examples, the system may determine whether the number of predetermined bidding rounds has been satisfied. For example, the system may determine, based on the request information and/or the buyer information, that the number of quotes provided by each seller (e.g., the number of bidding rounds) that was requested by the seller and/or predetermined by the system, has been satisfied. If the number of bidding rounds has been satisfied, the current quotes of each seller (e.g., the current accepted, modified, or declined quote) may be provided to the seller for acceptance. If the number of predetermined bidding rounds has not been satisfied, another bidding round may commence.

In some examples, in the event that another bidding round is required, a second quote may be generated for each seller desiring to fulfill the request. For example, a second quote may be generated for a seller based at least in part on the quotes accepted, modified, or declined during the first bidding round. Again, the second quote may be provided to the seller for acceptance, further modification, or to decline. This process may continue until the number of bidding rounds has been satisfied.

In some examples, in response to a buyer request, one or more sellers may wish to fulfill only a portion of the request. For example, the buyer may request a large volume of goods to be purchased. In response, one or more buyers may wish to provide only a portion of the volume of good. In this example, the system may generate a quote associated with each seller and the portion of the request the seller wishes to fulfill. In these cases, it is often desirable to have multiple suppliers or sellers and, thus, the offers to fulfill portions of a request may be ranked higher than offers to fulfill an entire request even at a higher price per unit.

Further, in examples, the system may perform an additional price-matching bidding round. For example, after the final bidding round, the system may conduct an additional bidding round including the price-matching bidding round. During the price-matching bidding round, the seller(s) may receive an indication of the lowest bid, based on the final quotes generated, that has been submitted by the sellers. In some examples, the indication may include the actual cost. In other examples, the indication may indicate a range associated with the lowest bid. The seller may then have an opportunity to match the lowest bid, as indicated. In this way, the system may be able to provide the price-matching bid estimate (e.g., an indication that each seller has matched the lowest bid) to the seller, along with the ranking of each seller. In this way, the buyer may choose the seller best suited to their needs for the particular transaction (e.g., the highest-ranking user based on the quotes, buyer preferences, historical transaction data, etc.), with all the bidding prices being substantially equal. As a result, the system may reduce computing resources associated with multi-entity and multi-criteria comparison, such as weighing various factors such as individual final quotes, seller characteristics, buyer preferences, and the like, by eliminating the price factor when determining the adjusted ranking of each seller for the buyer's consideration.

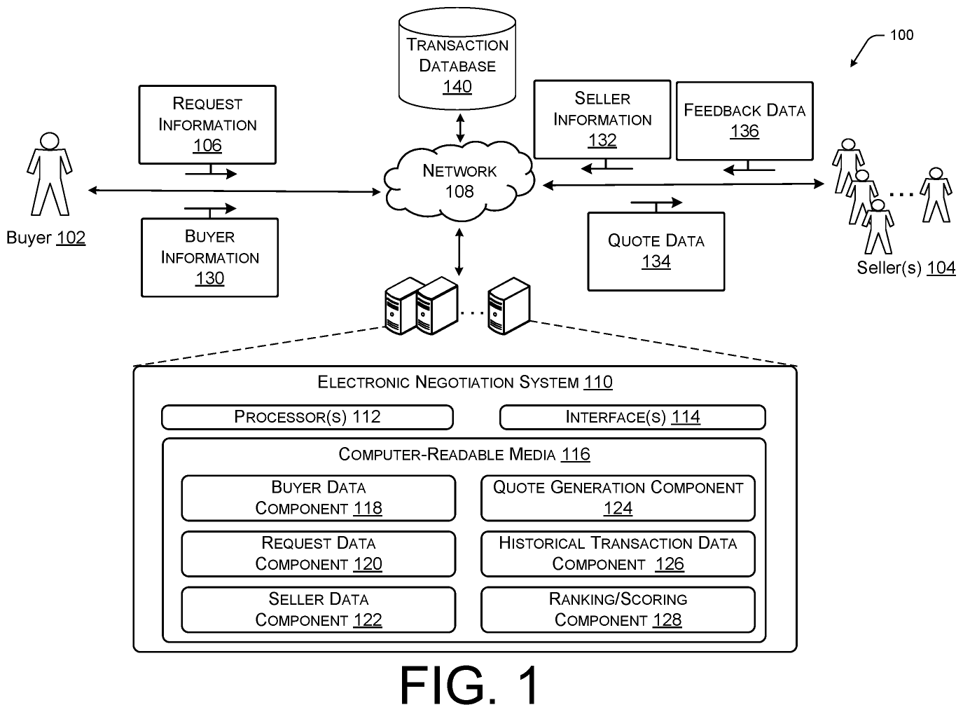

Additional details pertaining to the above-mentioned techniques are described below with reference to FIGS. 1-6. It is to be appreciated that while these figures describe example environments and devices that may utilize the claimed techniques, the techniques may apply equally to other environments, devices, and the like.

FIG. 1 illustrates an example environment 100 for an electronic negotiation system, as described herein. As illustrated in FIG. 1, the environment 100 includes a buyer 102 providing a request for a product or service and one or more seller(s) 104 capable of fulfilling at least a portion of the request. As described herein, the buyer 102 may provide request information 106, via a network 108, associated with a request for a product (e.g., goods and/or services) to an electronic negotiation system 110. In response to receiving the request information 106 from the buyer 102, the electronic negotiation system 110 may conduct one or more bidding rounds during which the seller(s) 104 may be provided one or more quotes generated by the electronic negotiation system 110 on behalf of the seller(s) 104 and/or the electronic negotiation system 110 may determine one or more rankings associated with individual sellers 104. It should be understood that, while FIG. 1 depicts one system, electronic negotiation system 110, the environment 100 may include any number of systems configured to operate independently and/or in combination and configured to communicate with each other via the network 108. The components of the electronic negotiation system 110 may be described in detail below.

In examples, the electronic negotiation system 110 may include one or more processors 112, one or more network interfaces 114, and computer-readable media 116. The computer-readable media 116 may store one or more functional components that are executable by processor(s) 112 such as a buyer data component 118, a request data component 120, a seller data component 122, a quote generation component 124, a historical transaction data component 126, and/or a ranking/scoring component 128. At least some of the components, modules, or instructions of the computer-readable media 116 may be described below.

In examples, the buyer data component 118 may be configured to store and/or access data associated with the buyer 102. For example, the buyer 102 may provide user data, such as buyer information 130, upon accessing the electronic negotiation system 110 and/or upon initiating a request for a product from one or more sellers 104 and/or a third-party. For instance, when a buyer 102 accesses the platform of the electronic negotiation system 110, the buyer 102 may provide the buyer information 130 regarding the buyer's company, preferences, and the like. For example, the buyer 102 may provide demographic information such as buyer location, size of an associated company, years in operation, and the like.

Alternatively, or in addition, the buyer 102 may provide buyer information 130 including user preferences associated with the buyer 102, future requests, and/or the seller(s) 104. For example, the buyer 102 may stipulate, and the buyer information 130 may include preferences regarding future requests and/or the fulfilling seller(s) 104 such as product preferences, seller preferences, and/or platform or system preferences. The product preferences may include product specifications of future requested products, such as production specifications, delivery methods, and the like. The seller preferences may include seller specifications, such as reputation of the seller 104 (e.g., a number of complete transactions, a number of transactions in which the seller 104 was participating as compared to a number of times the seller 104 was chosen, etc.), years in operation of the seller 104, and the like. The platform or system preferences may also include preferences such as notification preferences, user interface settings, and the like.

Still further, the buyer data component 118 may be configured to receive, access, and/or store historical buyer information 130 associated with the buyer 102 and/or additional buyers. For example, the buyer data component 118 may store previous buyer information 130 associated with the buyer 102 and/or other buyers who have utilized the electronic negotiation system 110. For instance, the buyer data component 118 may store previous buyer preferences, transaction history, patterns of buyer behavior, and the like. The buyer data component 118 may receive the buyer information 130 and/or may access such information via the network 108. For example, the buyer data component 118 may access an external database of the buyer 102 storing data associated with the buyer 102.

In addition, the computer-readable media 116 may store a request data component 120. The request data component 120 may be configured to receive, access, and/or store request information 106. For example, the buyer 102 may provide the request information 106 upon accessing the electronic negotiation system 110 and/or upon initiating a request for a product from one or more sellers 104 and/or a third-party. In some examples, the request information 106 may include information associated with a current request submitted by the buyer 102 to the electronic negotiation system 110. For instance, the request information 106 may include information regarding the product requested, such as the number of units, length of services, product requirements, each item of the product (e.g., each line item), and the like of the goods and/or services requested.

In addition, the request information 106 may include user preferences associated with the current request. For example, similar to the buyer information 130, the request information 106 may include preferences associated with the goods requested and/or the seller(s) 104 fulfilling the request. For instance, the request information 106 may include product preferences associated with the requested product, such as preferred quality standards of the product, product specifications, production preferences, and the like. In addition, the request information 106 may include buyer 102 preferences associated with the seller 104, such as a preferred rating of the company by other buyers, age of company, location of the seller(s) 104, etc. The request data component 120 may also be configured to receive, access, and/or store historical request information 106 associated with additional buyers and/or additional negotiation transactions. The request data component 120 may receive such information and/or may access such information via the network 108.

In some examples, the computer-readable media 116 may store a seller data component 122. The seller data component 122 may be configured to receive, access, and/or store seller information 132 provided by the seller 104. The seller 104 may provide user data, such as the seller information 132, upon accessing the electronic negotiation system 110 and/or upon initiating a response to fulfill a request for a product from the buyer 102. For example, the seller 104 may provide seller information 132 such as demographic information, company information (e.g., products offered, number of employees, location, years of operation, etc.) and/or seller 104 preferences (e.g., platform settings such as frequency of notifications, interface customization settings, authorization to accept quotes on the seller's 104 behalf without seller 104 input, etc.). For example, the seller 104 may provide information regarding terms and/or conditions under which the system may accept a bid on behalf of the seller without further input. Alternatively, or in addition, the seller 104 may provide the seller information 132 when the seller 104 first accesses the platform associated with the electronic negotiation system 110. For instance, when the seller(s) 104 first become a user of the electronic negotiation system 110, the seller(s) 104 may provide the seller information 132.

In addition, the seller data component 122 may be configured to receive, access, and/or store historical seller information 132 associated with the seller(s) 104 and/or previous seller(s) 104 that have utilized the electronic negotiation system 110. The seller data component 122 may receive such information and/or may access such information via the network 108. For example, the seller data component 122 may access an external database of the seller(s) 104 storing data associated with the seller(s) 104.

Further, the computer-readable media 116 may store a third-party data component 124. The third-party data component 124 may be configured to receive, access, and/or store the third-party information. The third-party information may include data from one or more third-party sources providing such information as market statistics, commodity information, and the like associated with at least one of the buyer, seller, and/or the requested product.

The computer-readable media 116 may further be configured to store a quote generating component 124. The quote generating component 124 may be configured to receive and/or access data from the buyer data component 118, the request data component 120, the seller data component 122, the historical transaction data component 126, and/or the ranking/scoring component 128 to generate quotes for the seller(s) 104. For example, utilizing buyer information 130 from the buyer data component 118, request information 106 from the request data component 120, seller information 132 from the seller data component 122, historical transaction data from the historical transaction data component 126, and/or ranking information from the ranking/scoring component 128, the quote generation component 126 may generate quote data 134 to provide to the one or more seller(s) 104. In some examples, the quote data 134 may include an individual quote generated during each bidding round on behalf of a seller 104 wishing to fulfill the request placed by the buyer 102. The quote may initially indicate a “should-cost” amount for the seller 104, that may change dynamically with each bidding round. In other words, the initially generated quote may indicate an expenditure that it should cost the seller 104 to provide the requested good and/or service to the buyer 102 according to the request information 106 and may be dynamically adjusted based on the negotiation process to generate additional quotes. The quote(s) may further be generated for each line item of the product. As described above, the quote(s) may be based on current and/or historical information associated with the buyer 102, request information 106, and/or seller 104.

In some examples, the quote data 134 may be provided to the seller(s) 104 via the network 108 for review. The quote data 134, including the quotes, may be provided to each seller 104 along with an option to provide feedback data 136 indicating at least one of an acceptance, modification, or rejection of the proposed, generated quote. In examples, the feedback data 136 must be provided to the electronic negotiation system 110 within the time period that the current bidding round will last (e.g., the time period for the bidding round stipulated by the buyer 102 in the request information 106). That is, the seller(s) 104 may accept, modify, or decline the quote before submitting a response or offer for acceptance by the buyer 102. Alternatively, or in addition, as described herein, the seller 104 may provide the electronic negotiation system 110 authorization to accept the quote on their behalf, without further input. The feedback data 136, including each seller's offer, may be stored within the seller data component 122, and/or the quote generation component 126, for use in generating additional quotes for the current negotiation, as well as future negotiations conducted by the electronic negotiation system 110.

Should the feedback data 136 indicate an acceptance of the quote, the quote may be provided to the buyer 102 for consideration during the current round. Should the seller 104 provide feedback data 136 indicating a modification of the quote, the quote may be modified to reflect the feedback data 136 and a final, modified quote may be provided to the buyer 102 Lastly, should the seller 104 decline the quote, the quote may nevertheless be provided for consideration to the buyer 102.

As described herein, the request information 132 may stipulate the time period that the seller(s) 104 must accept, modify, or decline the quote. In addition, the request information 106 may stipulate the number of rounds that may take place during the current negotiation. In some examples, the electronic negotiation system 110 may automatically determine a time period for response and/or the number of rounds that may take place based on the request information 132, historical information, and/or third-party information (e.g., if the market is volatile, the electronic negotiation system 110 may determine that the negotiation process should be expedited). By generating an offer on behalf of the seller(s) 104, in combination with not revealing competing offers to the seller(s) 104, placing a time period for feedback, and limiting the number of rounds that may take place, the incentive to place a last minute bid is decreased as the seller(s) 104 have no motivation to place last minute bids in order to have the lowest bid/be chosen. In this way, the electronic negotiation system 110 may better allocate and utilize computing resources as the likelihood of an inundation of bids at the same time is decreased (e.g., the seller(s) 104 won't all place last minute bids at the same time, thus overloading the system). As a result, the electronic negotiation system 110 resources may achieve better performance.

In additional examples, if the number of rounds has not been satisfied, updated or additional quotes may be generated on behalf of the seller(s) 104. For example, the quote generation component 126 may utilize the seller(s) 104 response data during previous bidding rounds of the current negotiation, and/or data from the buyer data component 118, the request data component 120, the seller data component 122, the historical transaction data component 126, and/or the ranking/scoring component 128, to generate updated quotes on behalf of the seller(s) 104. During each round, the seller(s) 104 may again have the option to accept, modify, or decline the generated quote. Once the number of rounds has been satisfied, the offers from each seller 104 may be provided to the buyer 102 for acceptance.

Still further, in examples, the quote generation component 126 may be configured to generate a price-matching bid for each seller 104. For example, the request information 106 may indicate, or the electronic negotiation system 110 may determine, that the auction should include a price-matching bidding round. During the price-matching bidding round, the quote generation component 126 may be configured to provide a price-matching bid to the seller 104 indicating a lowest bid associated with the seller(s) 104 participating in the electronic negotiation (e.g., a lowest price that has been submitted during previous rounds by the participating seller(s) 104). For example, the price-matching bid may indicate a value reflecting the lowest bid or a scrambled version of the lowest bid, such as a randomly assigned range that is stipulated by the seller 104 offering the lowest bid and/or determined by the electronic negotiation system 110. The range may reflect a slight modification to the lowest bid that may protect the confidentiality of the seller 104 associated with the bid while still enabling other sellers 104 to match the bid.

The price-matching bid may be provided to the other seller(s) 104 and the seller(s) 104 may have an opportunity to adjust their last quote to match the price-matching bid, or the lowest current bid. In this way, the electronic negotiation system 110 may provide the price-matching bid to the buyer 102 and the buyer 102 may select a seller 104 based on other factors, with the price being equal for all sellers 104. For example, the buyer 102 may select a user based on the ranking/score of the seller 104, as described below. By removing the cost considerations, the electronic negotiation system may determine ranking/scoring of sellers 104 based on less weighted factors and may therefore expend less computing resources.

In examples, the computer-readable media 116 may further be configured to store a historical transaction data component 126. The historical transaction data component 126 may be configured to receive and/or access historical transaction data from a transaction database 140 via the network 108. The historical transaction data may include information associated with previous transactions that have been conducted through the electronic negotiation system 110. The previous transactions may include transactions in which the buyer 102, seller(s) 104, and/or additional users have participated in. The historical transaction data may indicate various characteristics of the previous transactions, such as each line item of the product being negotiated for, seller characteristics, buyer characteristics, a price of the transaction, and the like.

In some examples, the computer-readable media 116 may further be configured to store a ranking/scoring component 128. The ranking/scoring component 128 may be configured to receive and/or access data from the buyer data component 118, the request data component 120, the seller data component 122, the quote generation component 124, and/or the historical transaction data component 126 to rank the participating seller(s) 104 with respect to one another and/or generate a score associated with the participating seller(s) 104. For example, utilizing buyer information 130 from the buyer data component 118 including current and previous buyer 102 preferences and/or acceptance behavior, the ranking/scoring component 128 may determine that the buyer 102 prefers seller(s) 104 that have been in operation for longer than ten years. Further utilizing the seller information 132 of the seller data component 122, the ranking/scoring component 128 may rank seller(s) 104 in operation for ten years or greater higher than those who have been operating for less than ten years.

Additionally, or alternatively, the ranking/scoring component 128 may generate a score associated with the seller(s) 104 indicating a likelihood that the seller 104 will win the bid and/or be selected by the buyer 102. The ranking and/or score may be provided to the buyer 102 in each bidding round along with the respect quotes. In addition, the ranking and/or score may affect the quote generation. For example, if a seller 104 is ranked lower with respect to other seller(s) 104 and/or has a low score associated, the quote generation component 126 may take this into account when generating the quote for that particular seller 104. That is, if a seller 104 is ranked lower and/or has a low score associated, the quote generation component 126 may generate a lower quote in order to offset the low-ranking displayed to the buyer 102 and increase the likelihood that the seller 104 may be selected.

Still further, the ranking/scoring component 128 may adjust the generated ranking and/or score, described herein and based on the current transaction data (e.g., seller preferences, request information 106, etc.), based at least in part on the historical transaction data. For example, a dynamic rank and/or score of the seller 104 may be determined based on a percentage of historical transactions in which the seller 104 was chosen, in light of the total number of transactions in which the seller 104 was eligible to be chosen (e.g., the percentage of auctions in which the seller 104 participated in and was chosen). In examples, the ranking/scoring component 128 may further take into account the reputation of a buyer, such as the experience level of the buyer, the professional knowledge of the buyer, and the like (e.g., sellers chosen by a buyer having a long-standing reputation may be associated with a higher rank than sellers chosen by more junior buyers). The ranking/scoring component 128 may also take into account the size of the transaction, such as the value of the transaction, the number of line items, and the like (e.g., sellers chosen for transactions that have a higher fulfillment price may be ranked higher than sellers chosen for smaller fulfillment prices).

In examples, the ranking/scoring component 128 may continually update a dynamic rank/score of the seller 104 as new transactions occur and/or may utilize the dynamic rank/score to update the current rank/score determined based on the current transaction data, such as data from the buyer data component 118, the request data component 120, the seller data component 122, as described herein. For example, if the buyer information 130 of the buyer data component 118 indicates that the buyer 102 prefers geographically close sellers 104, and the sellers 104 have been ranked accordingly based on the current transaction data, the ranking/scoring component 128 may utilize the dynamic rank/score of the seller 104, based on the historical transaction data and indicating a historical preference for the seller 104 in previous transactions, to update and provide a real-time rank/score associated with the seller 104.

In additional examples, the historical transaction data may indicate individual line items associated with previous transactions and/or business organizations. For example, the dynamic rank/score may reflect buyer preferences across business units and/or business entities. For example, in generating the dynamic rank/score for a seller 104 in association with a request from the buyer 102, the ranking/scoring component 128 may identifying a list of responsive vendors, identify historical transaction data associated with all categories that would fit within a parameter of the request information 106, assign a weight to each of the historical transaction requests originating entities based on a percentage of the total group spend that their transaction history accounts for, determine a preference score for each seller deemed responsive based on the percentage of transaction history for each originating entity, weighted based on the percentage of total category spend that each entity represents (i) a number of the identified links between the linking documents and the first linked document, and (ii) the weights assigned to each line item of the identified seller's catalogue, where each of these steps are repeated for each responsive seller and the sellers are organized based on the determined rank/score.

In another example, the ranking/scoring component 128 may identify a plurality of sellers with associated business transaction request history naming specific line items, identify historical transaction data indicating sets of transaction request history linking between one or more buyers and one or more sellers, assign a preference score to each line item based on (i) the number of available line items across the catalogues of every vendor in the database (ii) the number and size of those transactions across the vendor database associated with those line items; (iii) the frequency, and rank/score the sellers accordingly.

As used herein, a processor, such as processor(s) 112, can be a single processing unit or a number of processing units, and can include single or multiple computing units or multiple processing cores. The processor(s) 112 can be implemented as one or more microprocessors, microcomputers, microcontrollers, digital signal processors, central processing units, state machines, logic circuitries, and/or any devices that manipulate signals based on operational instructions. For example, the processor(s) 112 can be one or more hardware processors and/or logic circuits of any suitable type specifically programmed or configured to execute the algorithms and processes described herein. The processor(s) 112 can be configured to fetch and execute computer-readable instructions stored in the computer-readable media 116, which can program the processor(s) 112 to perform the functions described herein.

The computer-readable media 116 may can include volatile and nonvolatile memory and/or removable and non-removable media implemented in any type of technology for storage of information, such as computer-readable instructions, data structures, program modules, or other data. Such computer-readable media 116 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the electronic negotiation system 110, the computer-readable media 116 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 116 can be used to store any number of functional components that are executable by the processor(s) 112. In many implementations, these functional components comprise instructions or programs that are executable by the processor(s) 112 and that, when executed, specifically configure the one or more processor(s) 112 to perform the actions attributed above to the service provider and/or payment service.

The network interface(s) 114 may enable wired and/or wireless communications between the components and/or devices shown in environment 100 and/or with one or more other remote systems, as well as other networked devices. For instance, at least some of the network interface(s) 114 may include a personal area network component to enable communications over one or more short-range wireless communication channels. Furthermore, at least some of the network interface(s) 114 may include a wide area network component to enable communication over a wide area network.

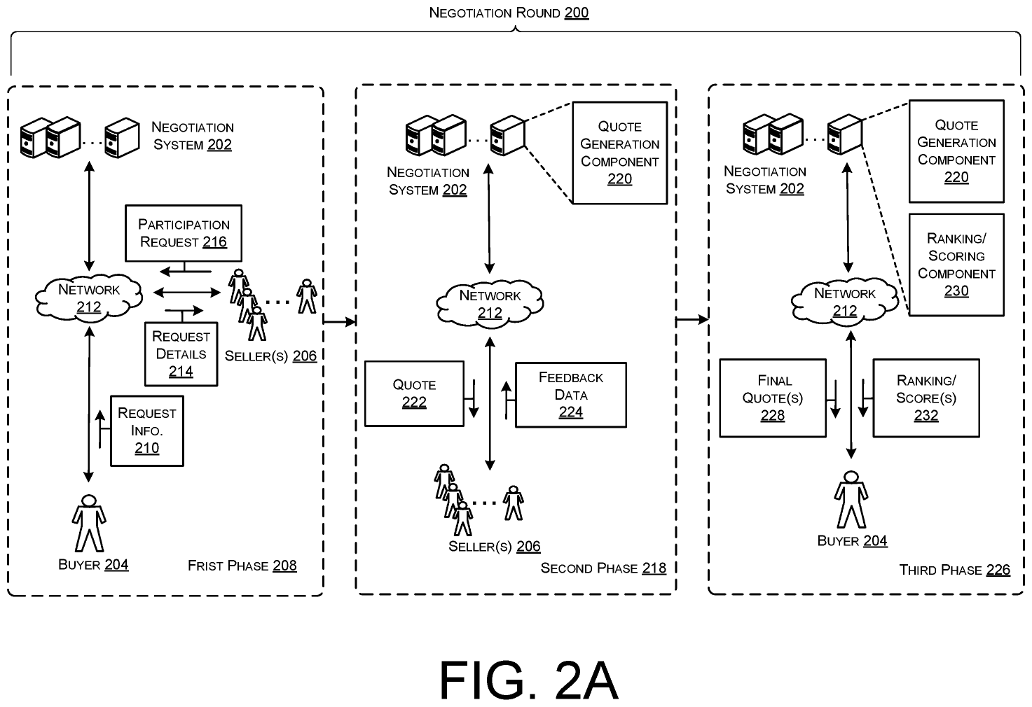

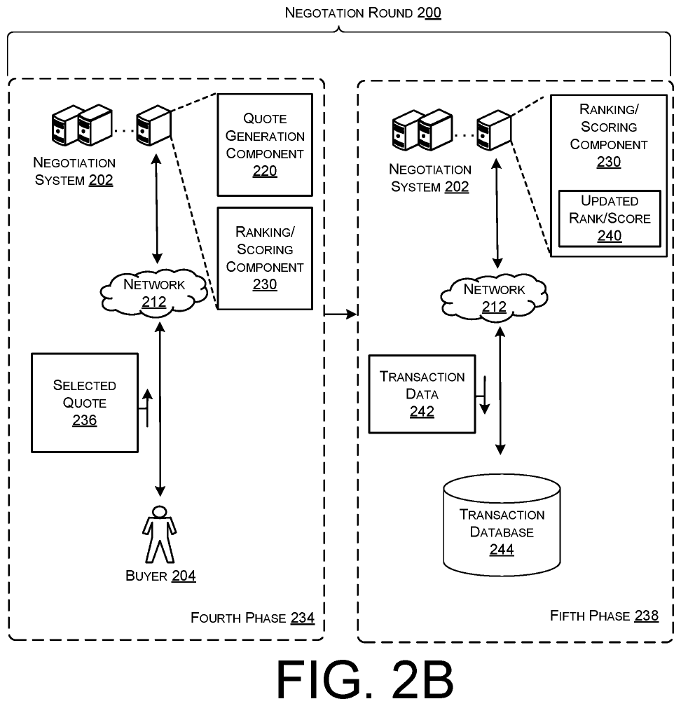

FIG. 2 illustrates an example cost estimation round 200 of an electronic negotiation system, such as the electronic negotiation system 110 of FIG. 1. During the round 200, an electronic negotiation system 202 may accept a request for a product from a buyer 204 for fulfillment by one or more seller(s) 206. In response to the request, the electronic negotiation system 202 may generate one or more quotes on behalf of the seller(s) 206 for acceptance by the buyer 204. As described herein, one or more rounds may take place during the automated negotiation. The number of rounds may be dictated by request information 208 received from the buyer 204 and/or determined utilizing additional data, such as data received and/or accessed from the seller, third-parties, historical transaction information, and the like.

During a first phase 208 of the negotiation round 200, the buyer 204 may provide request information 210, via the network 212, to the electronic negotiation system 202. As described with respect to FIG. 1, the request information 210 may include information associated with a current request submitted by the buyer 204 for a product (e.g., good and services). For instance, the request information 208 may include information and/or preferences regarding the product requested, such as the number of units, length of services, product specification, production preferences, line item entries for each item of the product, and the like, of the product requested. In addition, the request information 208 may include buyer 204 preferences associated with the seller(s) 206, such as a preferred rating of the company by other buyers, age of company, location of the seller(s) 206, etc.

In some examples, in response to receiving the request information 208, the electronic negotiation system 202 may provide the request details 214 to the seller(s) 206. The request details 214 may be provided via a user interface of a device associated with the seller 206, a user interface of a negotiation platform and/or negotiation application, and the like. For example, the seller(s) 206 may be presented with a user interface displaying all current requests, requests able to be fulfilled by the seller(s) 206, and/or requests associated with a particular buyer 204, and the like. Along with the request, the interface may further provide an option for the seller(s) 206 to place a participation request 216, such as an offer to participate in a negotiation associated with the request details 214. The participation request 216 may be provided, via the network 212, to the electronic negotiation system 202.

In examples, in response to the electronic negotiation system 202 receiving the participation request 216 from the seller(s) 206 and/or the expiration of a period of time associated with the first phase 208, the round 200 may enter a second phase 218. In the second phase 218, a quote generation component 220 of the electronic negotiation system 202, such as the quote generation component 124 of FIG. 1, may generate a quote 222 for each seller 206 that has provided a participation request 216 during the first phase 208. As described herein, the quote generation component 216 may utilize buyer information, the request information 210, seller information, third-party data, and/or ranking information to generate an initial quote on behalf of the seller 206. In subsequent rounds (not shown), the quote generation component 216 may further utilize previous feedback data associated with previous quote(s) provided by the seller(s) 206 to generate additional quotes on behalf of the seller(s) 206.

The electronic negotiation system 202 may then provide the quote(s) 222 to each corresponding seller(s) 206 for review. In response, each seller 206 may submit feedback data 224 associated with the quote(s) 222 to the system 202. For example, the quote(s) 222 may be provided to the seller(s) 206 along with an option to provide feedback data 224. The feedback data 224 may include at least one of acceptance, modification, or declination of the quote 222 within the time period associated with the negotiation round 200 (e.g., the time period for the negotiation round 200 indicated in the request information 210 provided by the buyer 204). For example, the quote 222 may be accepted by the seller 206 without modification. In this instance, the quote 222 may be submitted in the current negotiation round 200 as-is for acceptance by the buyer 204. Alternatively, the seller 206 may modify the quote 222 (e.g., increase or decrease the quote). Still further, the seller 206 may decline the quote 218. In this instance, while the seller 206 may not be eligible to be chosen by the buyer 204 or to proceed to subsequent rounds. However, in some examples, the declined quote 222 may still be provided to the buyer 204 for review.

In some examples, once each of the seller(s) 206 have provided the feedback data 224, indicating an acceptance, modification, or declination of the quote 222, and/or the expiration of a period of time associated with the second phase 218 and/or the negotiation round 200, the negotiation round 200 may enter a third phase 226. In the third phase 226, the quote generation component 220 of the negotiation system 220 may analyze the feedback data 224 provided by the seller(s) 206 to generate final quote(s) 228 associated with each seller 206 to be provided to the buyer 204 for selection of the seller(s) 206 to fulfill the request.

For example, based on the feedback data 224, the initial quote 222 associated with each seller 206 may be modified to reflect the indications of the feedback data 224. For example, if the feedback data 224 indicates that the seller 206 has accepted the quote 222 as-is, the final quote 228 may indicate the estimate included in the initial quote 222. In examples, if the seller 206 has chosen to modify the quote 222, the quote generation component 220 may modify the initial quote 222 to reflect the modifications provided by the seller 206 and generate a final quote 228. As described herein, the initial quote(s) 222 and final quote(s) 228 may be generated on a line-item basis, thereby indicating a value for fulfilling each item requested in the request information 208.

In addition to generating the final quote(s) 228 for each seller 206, a ranking/scoring component 230 of the electronic negotiation system 202, such as the ranking/scoring component 128 described in FIG. 1, may utilize the request information 208 and/or additional buyer 204 information (e.g., buyer preferences, buyer demographic information, past buy behavior, etc.) to generate a ranking/scoring 232 associated with the one or more seller(s) 206. For example, if the request information 208 stipulates that the buyer 204 prefers seller(s) 206 located within a certain distance of the buyer 204, the electronic negotiation system 202 may rank seller(s) 206 located within the preferred distance higher than other seller(s) 206 located outside of the preferred distance. In other examples, the ranking/scoring component 222 may generate a score associated with the seller(s) 206. For example, a seller 206 located within the preferred distance may receive a high score, indicating a high likelihood of selection. The ranking/scoring 224 may be provided along with the final quote(s) 222 to the buyer 204. Once the buyer 204 has received the final quote(s) 222 and the ranking/scoring 232, the buyer 204 may choose a seller for fulfillment of the request. The identity of the chosen seller 206 may be provided to the electronic negotiation system 202 and the chosen seller 206 may be notified.

In examples, the ranking/scoring component 230 may adjust the initial ranking/score(s) 232 associated with each seller 206 based on historical transactional data. For example, the ranking/scoring component 230 may adjust the generated ranking/score 232, described herein and based on the current transaction data (e.g., seller preferences, request information 210, etc.), based at least in part on a dynamic ranking/score associated with the historical transaction data. For example, a dynamic rank and/or score of the seller 206 may be determined based on a percentage of historical transactions in which the seller 206 was chosen, in light of the total number of transactions in which the seller 206 was eligible to be chosen (e.g., the percentage of auctions in which the seller 206 participated in and was chosen). In examples, the ranking/scoring component 230 may further take into account the reputation of a buyer associated with the historical transactions, such as the experience level of the buyer, the professional knowledge of the buyer, and the like (e.g., sellers chosen by a buyer having a long-standing reputation may be associated with a higher rank than sellers chosen by more junior buyers). The ranking/scoring component 230 may also take into account the size of the transaction, such as the value of the transaction, the number of line items, and the like (e.g., sellers chosen for transactions that have a higher fulfillment price may be ranked higher than sellers chosen for smaller fulfillment prices).

Thus, the ranking/score(s) 232 may be adjusted based on the dynamic ranking/score of the seller 206. For example, although the initial ranking/score 232 may indicate a highest-ranking seller 206 based on the seller preference of a user within a certain geographical distance, the current highest-ranking seller 206 may have a low dynamic rank. As such, the ranking/scoring component 230 may adjust the ranking/score 232 of the seller 206 to reflect the low dynamic ranking/score. In this way, sellers that have a higher dynamic ranking/score based on historical transactional data (e.g., sellers that have been historically chosen by reputable buyers) may have that information reflected along with the final quote(s) 228 and may have a better chance of being chosen by the buyer 204.

In examples, the ranking/scoring component 230 may continually update a dynamic rank/score of the seller 206 as additional transactions occur and/or may utilize the dynamic rank/score to modify the current rank/score 232 determined based on the current transaction data. For example, in the fourth phase 234 of the negotiation round 200, the buyer 204 may provide an indication to the negotiation system 202 of a selected quote 236 associated with the chosen seller 206. Subsequently, during the fifth phase 238 of the negotiation round 200, and based on the seller 206 being selected, an updated rank/score component 240 of the ranking/scoring component 230 may update, or modify, the dynamic ranking/score associated with the seller 206. Additionally, transaction data 242 associated with the negotiation round 200 (e.g., the request information 208, buyer information, seller information, selected seller 206, selected quote 236, etc.) may be stored in a transaction database 242 for use in determining a dynamic score/rank associated with each seller 206 utilizing the negotiation system 202.

FIGS. 2A and 2B illustrate a negotiation with a single round 200. However, as described herein, the number of rounds may vary according to one or more factors (e.g., the request information 208, seller information, historical information, market information, etc.) and more than one bidding round may be conducted. In instances with multiple rounds, the negotiation round 200 may followed by a subsequent round rather than a seller being selected during the fourth phase 234.

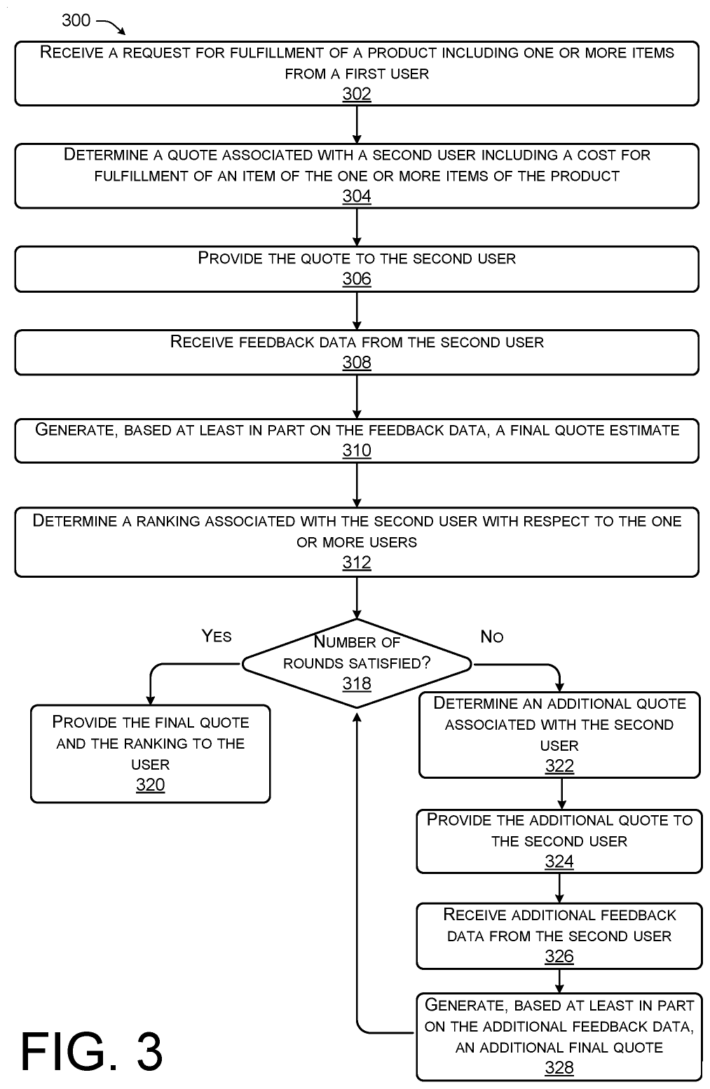

FIGS. 3-5 illustrate various flow diagrams of example process for electronic negotiations, as described herein. The processes illustrated in FIGS. 3-5 are described with reference to FIGS. 1 and 2, for convenience and ease of understanding. However, the processes illustrated in FIGS. 3-5 are not limited to being performed using components described in FIGS. 1 and 2, and such components are not limited to performing the processes illustrated in FIGS. 3-5.

The processes 300, 400, and 500 are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the processes 300, 400, and 500 can be combined in whole or in part with each other or with other processes.

FIG. 3 illustrates an example process 300 for an electronic negotiation according to some implementations. In some examples, operations described below can be performed by a system including local computing device(s) and/or remote computing device(s) that are in communication with the local computing device(s) (e.g., in a distributed configuration).

At operation 302, the system may receive a request for fulfillment of a product including one or more items from a first user. As described herein, a first user, such as a buyer, may submit a request to the automated negotiation system for a product, such as a good and/or service including one or more items (e.g., one or more individual line items). The request may include request information such as information associated with the product, buyer information, negotiation information (e.g., a number of bidding rounds, a number of quotes that may be accepted from each of the sellers during each bidding round, a time period for each bidding round, etc.) and the like. For example, the request may include information regarding buyer preferences with regard to the requested product, preferred seller characteristics, basic buyer information (e.g., demographic information), and the like. The request may further include information associated with each line item, such as line item specifications, and the like.

At operation 304, the system may determine a quote associated with a second user including a cost for fulfilment of an item of the one or more items of the product. For example, the one or more components of the negotiation system, as described herein, may access, receive, and or store information associated with buyer(s), seller(s), request(s), and/or third-party data. Utilizing this data, the system may generate one or more quotes associated with fulfilling the request on behalf of the second user, or seller. The quote(s) may indicate a cost associated with the seller to fulfill individual line items of the product requested by the buyer. For example, the quote may initially indicate a “should-cost value,” or a value it should-cost the seller to fulfill the request and/or the individual line items associated with the request and may be dynamically adjusted with each bidding round to generate additional quotes. The quote may represent an optimized value determined on behalf of the seller.

At operation 306, the system may provide the quote to the user. For example, the system may provide an indication of the quote to the second user with an option to at least one of accept, modify, or decline the quote. As described herein, if the second user chooses to accept or decline the quote, the quote may be provided as-is to the buyer for consideration. If the seller chooses to modify the quote, the quote may be modified by the system to reflect the indicated modifications.

At operation 308, the system may receive feedback data from the second user. As described herein, the second user, or seller, may choose to accept, modify, or decline the quote provided in operation 306. The feedback data may provide an indication of the acceptance, modification, or declination of the quote. The feedback data may further provide information regarding the modification the second user wishes to make to the quote, including value modifications for fulfilling the request and/or value modifications associated with individual line items associated with the requested product. In examples, the feedback data must be submitted by the second user within a predetermined period of time. For example, as described herein, the request may include a time period indicated by the first user, or buyer, for each bidding round (e.g., a time period the buyer wishes each round to last) and/or the system may determine how long each bidding period should last. Thus, the user may have a limited period of time during which they may review the quote and provide the feedback data.

At operation 310, the system may generate, based at least in part on the feedback data, a final quote. For example, utilizing the feedback data received at operation 308, the system may generate a final quote associated with the second user. For example, if the feedback data indicates that the second user has accepted the quote, the final quote may reflect the initial quote generated by the system. In further examples, if the feedback data indicates that the second user wishes to modify the quote, the system may modify the quote to reflect the indications provided by the second user to generate a final quote.

At operation 312, the system may determine a ranking associated with the second user with respect to the one or more users. For example, as described herein, a ranking/scoring component of the system may utilize the request information, buyer information, seller information, and the like to generate a ranking/scoring associated with the second user, or seller. Additionally, in examples, the system may adjust the initial ranking/score based on a dynamic ranking/score associated with the seller based on historical transactional data. In further examples, the system may continually update the dynamic rank/score of the seller as additional transactions occur and/or may utilize the dynamic rank/score to modify the current rank/score determined based on the current transaction data. As such, the ranking/score and/or the adjusted ranking/score associated with the seller may be provided to the buyer for consideration along with the final quotes at the conclusion of the negotiation.

At operation 318, the system may determine whether the number of rounds has been satisfied. As described herein, request information, and/or one or more other sources of data, may be utilized to determine a number of rounds that may take place.

If it is determined that the number of rounds has been satisfied, then at operation 320, the system may provide the first user with an indication of the final quote and the ranking associated with the second user. Once received, the buyer may choose to accept quote associated with the second user, from among the other users, to fulfill the request.

If, however, the system determines that the number of rounds has not been satisfied, then at operation 322, the system may determine an additional quote associated with the second user. As described herein, if the number of rounds has not been reached, the process may repeat itself, with a new or updated quote generated on behalf of the seller, and the other participating users, at each round. In some examples, in rounds subsequent to the first round, the automated negotiation system may utilize quote information and/or seller responses (e.g., the quotes accepted, modified, or declined by the seller) to generate the subsequent quotes for each seller.

At operation 324, the system may provide the additional quote to the second user. As described herein, the system may provide the additional quote to the second user and, at operation 326, the system may receive additional feedback data from the second user to at least one of accept, modify, or decline the additional quote. Utilizing the additional feedback data, at operation 328, the system may generate an additional final quote associated with the second user, and/or an updated ranking, to provide to the buyer. Once the number of rounds has been satisfied, the final quotes for each seller may be provided to the buyer for acceptance and selection, as discussed above.

While the process 300, is described with respect to a single seller, or the second user, it should be understood that any number of users, or sellers, may interact with the system in the manner discussed with respect to the second user until the number of bidding rounds has been satisfied and one of the users is selected to fulfill the request.

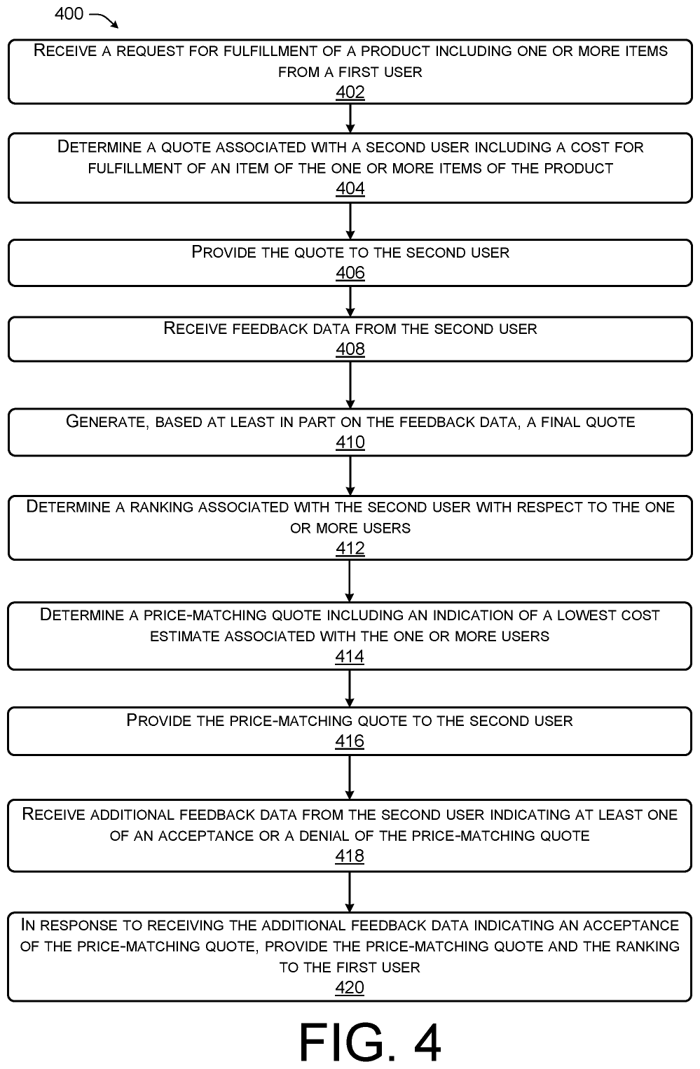

FIG. 4 illustrates another example process 400 for an electronic negotiation, as described herein. The process 300 of FIG. 3, discussed above, illustrates a negotiation having multiple rounds. However, the current process 400 illustrates an example in which the negotiation is concluded within a single round. At operation 402, the system may receive a request from a first user for fulfilment of a product including one or more items. As described herein, a first user, such as a buyer, may submit a request to the electronic negotiation system for a product, such as a good and/or service, and indicating one or more items associated with the product. The request may include request information such as information associated with the product, buyer information, the negotiation, and the like. For example, the request may include information regarding buyer preferences with regard to the requested product, preferred seller characteristics, basic buyer information (e.g., demographic information), a number of bidding rounds, a time period for each round, and the like.

At operation 404, the system may determine a quote associated with a second user including a cost for fulfilment of an item of the one or more items of the product. For example, the one or more components of the negotiation system, as described herein, may access, receive, and or store information associated with buyer(s), seller(s), request(s), and/or third-party data. Utilizing this data, the system may generate a quote associated with fulfilling individual items of the request on behalf of the second user, or seller. The quote may indicate an optimized value, “should-cost” value, and the like, associated with the seller to fulfill individual line items of the product requested by the buyer. For example, the quote may initially indicate a value that it should cost the seller to fulfill the request and/or the individual line items associated with the request and may be dynamically adjusted to generate additional quotes indicating adjusted values to fulfill the request and/or the individual line items.

At operation 406, the system may provide the quote to the user. For example, the system may provide an indication of the quote to a user device associated with the second user, via an application interface, and the like, with an option to at least one of accept, modify, or decline the quote. As described herein, if the second user chooses to accept or decline the quote, the quote may be provided as-is to the buyer for consideration. If the seller chooses to modify the quote, the quote may be modified by the system to reflect the indicated modifications.

At operation 408, the system may receive feedback data from the second user. As described herein, the second user, or seller, may choose to accept, modify, or decline the quote provided in operation 406. The feedback data may provide an indication of the acceptance, modification, or declination of the quote. The feedback data may further provide information regarding the modification the second user wishes to make to the quote, including value modifications for fulfilling the request and/or value modifications associated with individual line items associated with the requested product. In examples, the feedback data must be submitted by the second user within a predetermined period of time. For example, as described herein, the request may include a time period indicated by the first user, or buyer, for each bidding round (e.g., a time period the buyer wishes each round to last) and/or the system may determine how long each bidding period should last. Thus, the user may have a limited period of time during which they may review the quote and provide the feedback data.

At operation 410, the system may generate, based at least in part on the feedback data, a final quote. For example, utilizing the feedback data received at operation 408, the system may generate a final quote associated with the second user. For example, if the feedback data indicates that the second user has accepted the quote, the final quote may reflect the initial quote generated by the system. In further examples, if the feedback data indicates that the second user wishes to modify the quote, the system may modify the quote to reflect the indications provided by the second user to generate a final quote.

At operation 412, the system may determine a ranking associated with the second user with respect to the one or more users. For example, as described herein, a ranking/scoring component of the system may utilize the request information, buyer information, seller information, and the like to generate a ranking/scoring associated with the second user, or seller. Additionally, in examples, the system may adjust the initial ranking/score based on a dynamic ranking/score associated with the seller based on historical transactional data. In further examples, the system may continually update the dynamic rank/score of the seller as additional transactions occur and/or may utilize the dynamic rank/score to modify the current rank/score determined based on the current transaction data. As such, the ranking/score and/or the adjusted ranking/score associated with the seller may be provided to the buyer for consideration along with the final quotes at the conclusion of the negotiation.

At operation 414, the system may determine a price-matching quote including an indication of a lowest quote associated with the one or more users. For example, as described herein, the system may determine, or the request received at operation 402 may indicate, that the auction should include a price-matching bidding round. During the price-matching bidding round, the system, such as the quote generation component described herein, may be configured to provide a price-matching bid to the second user, or seller, indicating a lowest bid associated with the one or more other users participating in the electronic negotiation (e.g., a lowest price that has been submitted during previous rounds by the participating seller(s)). For example, the price-matching bid may indicate a value reflecting the lowest bid or a scrambled version of the lowest bid, such as a randomly assigned range that is stipulated by the user offering the lowest bid and/or determined by the system. The range may reflect a slight modification to the lowest bid that may protect the confidentiality of the user associated with the bid while still enabling the second user to match the bid.

At operation 416, the system may provide the price-matching quote to the second user. For example, the price-matching bid may be provided to the seller and the seller may have an opportunity to adjust their quote to match the price-matching bid, or the lowest current bid. For example, the system may provide the price-matching quote to the second user along with an option to accept or deny the price-matching quote.

At operation 418, the system may receive additional feedback data from the second user indicating at least one or an acceptance or a denial of the price-matching quote. For example, the feedback data may indicate that the second user has denied the price-matching quote. In response, the system may keep the final quote generated at operation 410 in association with the second user. As such, the final quote generated at operation 410 may be provided to the first user at the conclusion of the bidding round (should the number of bidding rounds be satisfied). Alternatively, the second user may provide feedback data indicating that the second user has accepted the price-matching quote. In this example, the system may modify the final quote generated at operation 410 to indicate the price-matching quote. As such, the price-matching quote will be provided to the buyer in associated with the second user.

At operation 420, the system, in response to receiving the additional feedback data indicating an acceptance of the price-matching quote, may provide the price-matching quote and the ranking to the first user. For example, as described herein, if the user provides feedback data at operation 418 indicating that they have accepted the price-matching quote, the system may modify the final quote associated with the second user to reflect the accepted price-matching quote. As such, the system may provide the price-matching quote, along with the ranking determined at operation 412, to the first user, or buyer, for acceptance. In this way, should all participating users accept the price-matching quote, the system may provide the price-matching bid to the buyer and the buyer may select a seller based on other factors, such as the adjusted ranking/score, with the price being equal for all sellers. Further, by removing the cost considerations, the system may determine a final ranking/scoring of sellers based on less weighted factors (e.g., excluding cost consideration and/or other current transaction data) and may therefore expend less computing resources.

While the process 400, is described with respect to a single seller, or the second user, it should be understood that any number of users, or sellers, may interact with the system in the manner discussed with respect to the second user until the number of bidding rounds has been satisfied and one of the users is selected to fulfill the request.

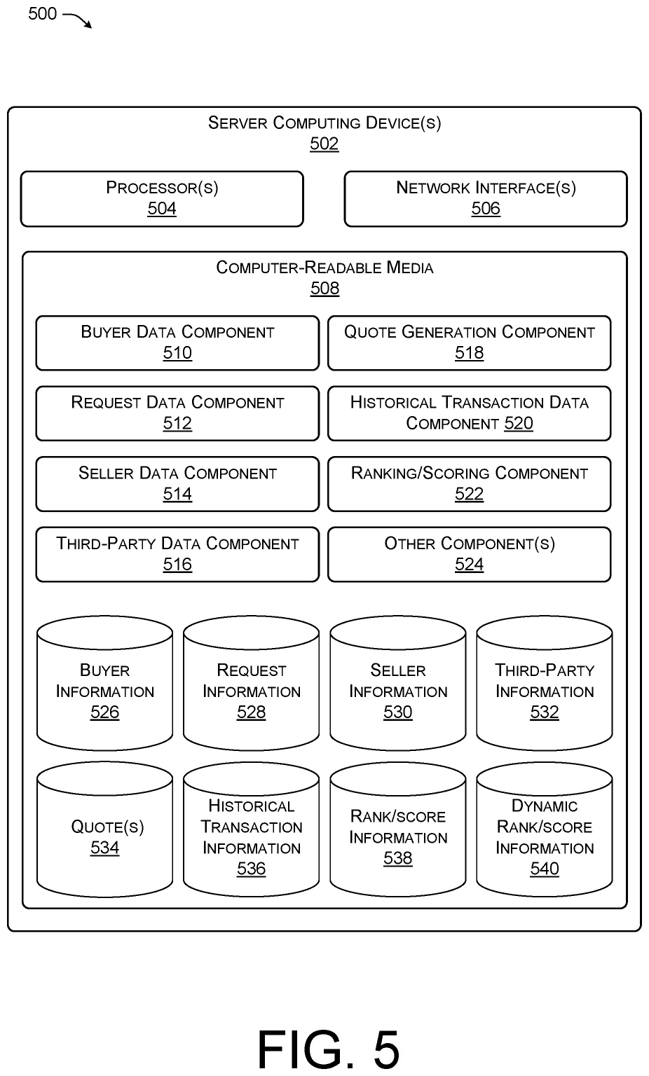

FIG. 5 illustrates an example server computing device 502 of an electronic negotiation system 500 for performing techniques as described herein. As described herein, one or more user computing devices can communicate with one or more intermediary computing devices, such as the electronic negotiation systems 110, 202, 500 described herein. The server computing device(s) 502 (“server(s)” hereinafter) can include one or more servers or other types of computing devices that can be embodied in any number of ways. For example, in the example of a server, the modules, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 502 as being present in a single location, these components and data can alternatively be distributed across different computing devices and different locations in any manner. In some examples, such components and data can be distributed across user computing devices, as described herein. The functions can be implemented by one or more server computing devices, with the various functionality described above distributed in various ways across the different computing devices. Multiple server(s) 502 can be located together or separately, and organized, for example, as virtual servers, server banks and/or server farms.

In some examples, the server(s) 502 may perform the same or similar functions as the electronic negotiation system described in FIGS. 1-4. The server(s) 502 may comprise processor(s) 504 that are operatively connected to network interface(s) 506 and a computer-readable media 508. Each processor 504 can be a single processing unit or a number of processing units and can include single or multiple computing units or multiple processing cores. The processor(s) 504 can be implemented as one or more microprocessors, microcomputers, microcontrollers, digital signal processors, central processing units, state machines, logic circuitries, and/or any devices that manipulate signals based on operational instructions. For example, the processor(s) 504 can be one or more hardware processors and/or logic circuits of any suitable type specifically programmed or configured to execute the algorithms and processes described herein. The processor(s) 504 can be configured to fetch and execute computer-readable instructions stored in the computer-readable media 508, which can program the processor(s) 504 to perform the functions described herein.

The computer-readable media 508 can include volatile and nonvolatile memory and/or removable and non-removable media implemented in any type of technology for storage of information, such as computer-readable instructions, data structures, program modules, or other data. Such computer-readable media 506 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 502, the computer-readable media 508 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 508 can be used to store any number of functional components that are executable by the processor(s) 504. In many implementations, these functional components comprise instructions or programs that are executable by the processor(s) 504 and that, when executed, specifically configure the one or more processors 504 to perform the actions attributed above to the automated negotiation system. Functional components stored in the computer-readable media 508 can include a buyer data component 510, a request data component 512, a seller data component 514, a third-party data component 516, a quote generation component 518, a historical transaction data component 520, a ranking/scoring component 522, as well as other component(s) 524. The computer-readable media 508 may also store buyer information 526, request information 528, seller information 530, third-party information 532, quote(s) 534, historical transaction information 536, rank/score information 538, and/or dynamic rank/score information 540.

In examples, the computer-readable media 508 may include the buyer data component 510. The buyer data component 510 may be configured to receive, access, and/or store buyer information 526. For example, the buyer data component 510 may be configured to access a database associated with the buyer and/or storing buyer information 526, such as information regarding buyer operations, a company associated with the buyer, and the like. As another example, the buyer data component 510 may also be configured to receive the buyer information 526 directly from the buyer. For example, when the buyer is initiating a transaction with the electronic negotiation system, such as electronic negotiation system 110 or 202, the buyer may provide basic information, such as address, number of employees, buyer preference, and the like, that may be stored in association with a buyer profile or directly in the buyer data component 510. The buyer information 526 may include buyer preferences with regard to user interface settings, notification preferences, negotiation preference (e.g., a number of bidding rounds to be conducted for a current or future negotiation, etc.), seller preferences, and the like. The buyer information 526 may further include historical buyer information associated with the buyer, such as information associated with past behavior of the buyer, past negotiation selections, past negotiation preferences, and the like. The buyer data component 510 may be configured to access and/or receive such data via the network interface 506 of the server computing device 502.

In examples, the computer-readable media 508 may further include a request data component 512. The request data component 512 may be configured to receive, access, and/or store request information 528. The request information 528 may include current request information provided by the buyer upon initiating a transaction with the automated negotiation system. For example, the buyer may provide request information including, but not limited to, a volume of goods and/or services requested, a line item accounting of each item associated with her goods and/or services requested, a timeline requested for providing the requested goods and/or services, negotiation preferences (e.g., a number of bidding rounds that may be accepted, a time period for responding to the generated quotes by the seller, etc.), and the like. Alternatively, or in addition, as described herein, the electronic negotiation system 500 may utilize the request information 528, along with data associated with at least one of the buyer, seller, third-party data, and the like, to determine the negotiation preferences.

In addition, the request information 528 may further be include historical request information, such as information associated with previous transactions conducted via the electronic negotiation system 500. The historical request information may include request information associated with previous transactions associated with one or more buyers that have utilized the electronic negotiation system 500, such as a volume of goods and/or services requested, a line item accounting of each item associate with the goods/services, a timeline requested for providing the requested goods and/or services, negotiation preferences, and the like, stipulated by users in previous transactions. The request data component 512 may be configured to access and/or receive such data via the network interface 506 of the server computing device 502.

Further, the memory may include a seller data component 514. The seller data component 514 may be configured to access, request, and/or store seller information 530 associated with a seller. For example, the seller data component 514 may be configured to access a seller database associated with the seller and storing seller information 530, such as information regarding seller operations, company information associated with the seller (e.g., a size of the company, a location of the company, products provided, etc.), and the like. As another example, the seller data component 514 may also be configured to receive the seller information 530 directly from the seller. For example, when the seller is initiating an interaction with the automated negotiation system 500, the seller may provide information, such as an address, number of employees, products provided, and the like, that may be stored in association with a seller profile or directly in the seller data component 514. The seller information 530 may further include historical seller information associated with the seller, such as past behavior of the seller, past negotiation behaviors (e.g., modification of quotes provided, timeliness of responding to quotes, timeliness of fulfilling the request, etc.), past negotiation preferences, and the like. In addition, the seller may provide the historical seller information directly to the seller data component 514. The seller data component 514 may be configured to access and/or receive such data via the network interface 506 of the server computing device 502.

In examples, the computer-readable media 508 may further include a third-party data component 516. For example, the third-party data component 516 may be configured to access a third-party database associated with third-parties and storing third-party information 532. The third-party data component 516 may further be configured to access and/or receive third-party information 532 associated with various third-party information providers. For example, the third-party data component 716 may be configured to access market information associated with a requested product, commodity patterns associated with a product, seller/buyer reviews, and the like.

The computer-readable media 708 may further include a quote generation component 518. The quote generation component 518 may be configured to generate quote(s) 534 associated with each seller participating in a negotiation, or bidding, round. For example, as described herein, when a seller decides to participate in a round to compete for fulfillment of the seller request, the quote generation component 518 may access and/or receive data associated with the request. For example, the quote generation component 518 may access and/or receive data from at least one of the buyer data component 510, the request data component 512, the seller data component 514, the third-party data component 516, the historical transaction data component 520, the ranking/scoring component 522, and/or the other component(s) 524. The quote generation component 518 may utilize some, or all, of this data to generate a quote associated with each seller and indicating a value for the seller to fulfill the seller request and/or each line item associated with the requested.

For example, the quote generation component 518 may utilize request information 528 indicating a volume of each line item requested, along with seller information 530 indicating the volume of each line item each seller is capable of providing, to generate the quote for each seller. In additional examples, the quote generation component 518 may utilize request information 528 indicating a seller preference for a quick turnaround, along with seller information 530 indicating the size of each seller's production facility, to generate the quote.

In still further examples, the quote generation component 518 may utilize rank/score information 538 when generating the quote for a seller. For example, the buyer information 526 may indicate a preference for older companies, while with seller information 530 indicates that a particular seller is a newly formed company. This information may result in the ranking/scoring component 522 generating low rank/score information 538 in association with the seller. Utilizing this rank/score information 538, along with the request information 528 and seller information 530, the quote generation component 518 may generate a lower quote for this particular seller. In this way, the quote is optimized to increase the likelihood that the quote is competitive, in light of the seller preferences and low seller ranking and increase the likelihood that the seller may be selected.

In some examples, a seller may wish to only fulfill a portion of the request, such as a particular line item. As described herein, in this instance, the quote generation component 518 may provide a quote to each seller according to the portion/line item they wish to fulfill. In this way, multiple negotiations are unnecessary, and quotes for each portion may be determined and presented to the seller within a single negotiation. This may help eliminate costly resource expenditures associated with conducting multiple negotiations, as well as prevent unoptimized bids when each portion is bid for in separate negotiations. That is, the techniques described herein generate quotes taking into account each portion that each seller wishes to fulfill, thereby optimizing the bidding process for the full request.

In examples, the computer-readable media 508 may further include a historical transaction data component 520. For example, the historical transaction data component 520 may be configured to access and/or receive historical transaction information 536 associated with historical transactions conducted via the electronic negotiation system 500. The historical transaction information 536 may include information associated with historical transactions conducted between all of the buyers and sellers utilizing the electronic negotiation system. The historical transaction information 536 may include information with the transactions such as request information, buyer information, seller information, the product(s) requested, individual line items associated with the product, a financial value of the transaction, the reputation of the buyer, the reputation of the seller, and the like.

The computer-readable media 508 may further include a ranking/scoring component 522. The ranking/scoring component 522 may store rank/score information 538 and/or dynamic rank/score information 540. The ranking/scoring component 522 may be configured to determine a ranking of one or more sellers with respect to each other and/or a score associated with one or more sellers per round of a negotiation. For example, the ranking/scoring component 522 may be configured to access and/or receive data from at least one of the buyer data component 510, the request data component 512, the seller data component 514, and/or the third-party data component 516 to generate the rank/score information 538 associated with the one or more sellers.

For example, the ranking/scoring component 522 may receive request information 528 from the request data component 512, buyer information 526 from the buyer data component 510, along with seller information 530 from the seller data component 514. In an example, the request information 528 and/or the buyer information 526 may indicate that the buyer prefers merchants that are located within a certain distance of the buyer. In addition, the seller information 530 may indicate that an address of the seller(s). Utilizing the request information 528 and the seller information 530, the ranking/scoring component 522 may rank each seller according to a threshold distance from a location of the buyer, with sellers located outside of the threshold distance being ranked lower. The rank/score information 538 may be provided to the buyer. Additionally, or alternatively, the ranking/scoring component 522 may utilize the request information 528 and the seller information 530 to determine a score associated with each seller indicating a likelihood of selection by the seller and/or the likelihood that the seller will win the bid. For example, sellers located outside of the threshold distance may receive a low score. In some examples, the scoring capacity of the system may be utilized in instances where there is a single seller. The determined rank/score information 538 may be stored for future use by the electronic negotiation system 500.

In examples, the ranking/scoring component 522 may also be configured to determine dynamic rank/score information 540 associated with sellers. For example, the ranking/scoring component 522 may be configured to receive and/or access historical transaction information 536 from the historical transaction data component 520 to determine a dynamic rank and/or score associated with the seller. In examples, the dynamic rank/score information may be based in part on a percentage of historical transactions in which the seller was chosen, in light of the total number of transactions in which the seller was eligible to be chosen (e.g., the percentage of auctions in which the seller participated in and was chosen). In examples, the ranking/scoring component 522 may further take into account the reputation of a buyer, such as the experience level of the buyer, the professional knowledge of the buyer, and the like (e.g., sellers chosen by a buyer having a long-standing reputation may be associated with a higher rank than sellers chosen by more junior buyers). The ranking/scoring component 522 may also take into account the size of the transaction, such as the value of the transaction, the number of line items, and the like (e.g., sellers chosen for transactions that have a higher fulfillment price may be ranked higher than sellers chosen for smaller fulfillment prices). In examples, the ranking/scoring component 522 may continually update, or modify the dynamic rank/score information 540 associated with of the seller as new transactions occur and/or may utilize the dynamic rank/score to update, or modify, the rank/score information 538 determined based on the current transaction data, as described herein.

It should be noted that reference to an “embodiment” in this document does not limit the described elements to a single embodiment; all described elements may be combined in any embodiment in any number of ways. Furthermore, for the purposes of interpreting this specification, the use of “or” herein means “and/or” unless stated otherwise. The use of “a” or “an” herein means “one or more” unless stated otherwise. The use of “comprise,” “comprises,” “comprising,” “include,” “includes,” and “including” are interchangeable and not intended to be limiting. Also, unless otherwise stated, the use of the terms such as “first,” “second,” “third,” “upper,” “lower,” and the like do not denote any spatial, sequential, or hierarchical order or importance, but are used to distinguish one element from another. It is to be appreciated that the use of the terms “and/or” and “at least one of”, for example, in the cases of “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

It should also be appreciated by those skilled in the art that any block diagrams, steps, or sub-processes herein represent conceptual views of illustrative systems embodying the principles of the present subject matter. Similarly, it may be appreciated that any flow charts, flow diagrams, state transition diagrams, pseudo code, and the like represent various processes which may be substantially represented in computer readable medium and so executed by a computer or processor, whether or not such computer or processor is explicitly shown. The order in which the methods are described are not intended to be construed as a limitation, and any number of the described method blocks can be deleted, moved, added, subdivided, combined, and/or modified in any order to implement the methods, or an alternative combination or sub-combinations. Also, while steps, sub-processes or blocks are at times shown as being performed in series, some steps, sub-processes or blocks can instead be performed in parallel, or can be performed at different times as may be recognized by a person of ordinary skill in the art. Further any specific numbers noted herein are only examples; alternative implementations can employ differing values or ranges. Furthermore, the methods and implementations described herein can be implemented in any suitable hardware, software, firmware, or combination thereof. For example, the methods and implementations described herein can utilize a number of user interfaces, including but not limited to any or all of user interfaces rendered via a device terminal (e.g., a keypad, a touchscreen, etc.), software installed on user devices (e.g., a mobile application, messaging services, etc.), a tablet computer, or a web interface. Furthermore, these user interfaces are often but not always supported by Internet cloud services.

The foregoing is merely illustrative of the principles of this disclosure and various modifications can be made by those skilled in the art without departing from the scope of this disclosure. The above described examples are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process limitations (e.g., dimensions, configurations, components, process step order, etc.) can be made to further optimize the provided structures, devices and methods, as shown and described herein. In any event, the structures and devices, as well as the associated methods, described herein have many applications. Therefore, the disclosed subject matter should not be limited to any single example described herein, but rather should be construed in breadth and scope in accordance with the appended claims.

What is claimed is:

1. A system comprising:
one or more processors; and
computer-readable media storing first computer-executable instructions that, when executed by the one or more processors, cause the one or more processors to perform operations comprising:
receiving, from a first user, a request for fulfillment of a product including one or more items, the request for fulfillment including a number of bidding rounds, and wherein a quote may be accepted from one or more users capable of fulfilling the request during individual bidding rounds;
determining a quote associated with a second user of the one or more users, the quote including a cost for fulfillment of an item of the one or more items of the product;
providing the quote to the second user;
receiving feedback data from the second user indicating at least one of an acceptance, a modification, or a denial of the quote;
generating, based at least in part on the feedback data, a final quote;
determining a ranking associated with the second user with respect to the one or more users;
determining whether the number of bidding rounds has been satisfied; and
in response to determining that the number of bidding rounds has been satisfied, providing the final quote and the ranking to the first user.

2. The system of claim 1, wherein the determining the ranking associated with the second user comprises:
determining, based on at least one of first user data or second user data, an initial ranking associated with the second user;
identifying the one or more users capable of fulfilling the request, the one or more users including at least the second user;
accessing historical transaction data associated with the one or more users, the historical transaction data including a percentage of requests to individual users of the one or more users for fulfilment of transactions associated with a category of products;
identifying at least one of an experience level or a financial obligation associated with the requests; and
modifying, based at least in part on at least one of the historical transaction data, the experience level, or the financial obligation, the initial ranking associated with the second user with respect to the one or more users to generate the ranking.

3. The system of claim 2, wherein the historical transaction data further includes an indication of one or more items associated with individual requests and wherein determining the ranking is further based at least in part on the indication of the one or more items.

4. The system of claim 2, the operations further comprising:
receiving, from the first user, a selection of the second user, the selection indicating that the second user has been chosen to fulfill the request;
sending an indication of the selection to the second user; and
modifying the ranking associated with the second user based at least in part on the selection of the second user.

5. The system of claim 1, wherein the ranking comprises a first ranking, the response data comprises first response data, and the quote comprises a first quote, and the operations further comprising:
determining that the number of bidding rounds has not been satisfied;
in response to determining that the number of bidding rounds has not been satisfied, determining a second quote associated with the second user;
providing the second quote to the second user;
receiving second feedback data from the second user indicating at least one of an acceptance, a modification, or a denial of the second quote;
generating, based at least in part on the feedback data, a final second quote;
determining that the number of quotes has been satisfied; and
in response to determining that the number of quotes has been satisfied, providing the final second quote and the ranking to the buyer.

6. The system of claim 1, wherein the feedback data comprises first feedback data, and the operations further comprising:
determining a price-matching quote including an indication of a lowest quote associated with the one or more users;
providing the price-matching quote to the second user;
receiving second feedback data from the second user indicating at least one of an acceptance or a denial of the price-matching quote; and
in response to receiving the second feedback data indicating an acceptance of the price-matching quote, providing the price-matching quote and the ranking to the first user.

7. The system of claim 1, wherein the request further indicates a length of time associated with individual bidding rounds of the number of bidding rounds, the length of time indicating a time prior to which the quote must be provided to the first user.

8. A computer-implemented method comprising:
receiving, from a first user, a request for a product including one or more items;
receiving a response from a second user to fulfill the request;
determining a quote associated with the second user, the quote including a cost for the second user to fulfill an item of the one or more items;
providing the quote to the second user;
receiving feedback data associated with the quote from the second user;
generating, based at least in part on the feedback data, a final quote;
determining a ranking associated with the second user with respect to the one or more users; and
providing the final quote and the ranking to the first user.

9. The computer-implemented method of claim 8, wherein the request further indicates at least one of a number of bidding rounds or a length of time associated with individual bidding rounds of the number of bidding rounds, the length of time indicating a time prior to which the quote must be provided to the first user.

10. The computer-implemented method of claim 9, further comprising:
determining whether the number of bidding rounds has been satisfied; and
wherein providing the final quote and the ranking to the first user is based at least in part on determining that the number of bidding rounds has been satisfied.

11. The computer-implemented method of claim 10, wherein the ranking comprises a first ranking, the response data comprises first response data, and the quote comprises a first quote, and the operations further comprising:
determining that the number of bidding rounds has not been satisfied;
in response to determining that the number of bidding rounds has not been satisfied, determining a second quote associated with the second user;
providing the second quote to the second user;
receiving second feedback data from the second user;
generating, based at least in part on the feedback data, a final second quote;
determining that the number of quotes has been satisfied; and
in response to determining that the number of quotes has been satisfied, providing the final second quote and the ranking to the buyer.

12. The computer-implemented method of claim 8, wherein the determining a ranking associated with the second user comprises:
determining, based on at least one of first user data or second user data, an initial ranking associated with the second user;
identifying the one or more users capable of fulfilling the request, the one or more users including at least the second user;
accessing historical transaction data associated with the one or more users, the historical transaction data including a percentage of requests to individual users of the one or more users for fulfilment of transactions associated with a category of products;
identifying at least one of an experience level or a financial obligation associated with the requests; and
modifying, based at least in part on at least one of the historical transaction data, the experience level, or the financial obligation, the initial ranking associated with the second user to determine the ranking with respect to the one or more users.

13. The computer-implemented method of claim 12, wherein the historical transaction data further includes an indication of one or more items associated with individual requests and wherein determining the ranking is further based at least in part on the indication of the one or more items.

14. The computer-implemented method of claim 8, wherein the feedback data comprises first feedback data, and the operations further comprising:
determining a price-matching quote including an indication of a lowest quote associated with the one or more users;
providing the price-matching quote to the second user;
receiving second feedback data from the second user indicating at least one of an acceptance or a denial of the price-matching quote; and
in response to receiving the second feedback data indicating an acceptance of the price-matching quote, providing the price-matching quote and the ranking to the first user.

15. A computer-implemented method comprising:
receiving, from a buyer, a request for fulfillment of a product including one or more items, the request for fulfillment including a number of bidding rounds during which a quote may be accepted from one or more users capable of fulfilling the request;
determining a quote associated with a second user including a cost for the second user to fulfill an item of the one or more items of the product;
providing the quote to the second user;
receiving feedback data associated with the quote from the second user;
generating, based at least in part on the feedback data, a final quote;
determining whether the number of bidding rounds has been satisfied; and
in response to determining that the number of bidding rounds has been satisfied, providing the final quote to the first user.

16. The computer-implemented method of claim 15, wherein the response data comprises first response data and the quote comprises a first quote, and further comprising:
determining that the number of bidding rounds has not been satisfied;
in response to determining that the number of bidding rounds has not been satisfied, determining a second quote associated with the second user;
providing the second quote to the second user;
receiving second feedback data from the second user;
generating, based at least in part on the feedback data, a final second quote;
determining that the number of quotes has been satisfied; and
in response to determining that the number of quotes has been satisfied, providing the final second quote to the buyer.

17. The computer-implemented method of claim 15, further comprising:
identifying the one or more users capable of fulfilling the request, the one or more users including at least the second user;
accessing historical transaction data associated with the one or more users, the historical transaction data including a percentage of requests to individual users of the one or more users for fulfilment of transactions associated with a category of products;
identifying at least one of an experience level or a financial obligation associated with the requests;
determining, based at least in part on at least one of the historical transaction data, the experience level, or the financial obligation, a ranking associated with the second user with respect to the one or more users; and
providing the ranking to the buyer with the final quote.

18. The computer-implemented method of claim 17, wherein the historical transaction data further includes an indication of one or more items associated with individual requests and wherein determining the ranking is further based at least in part on the indication of the one or more items.

19. The computer-implemented method of claim 15, wherein the feedback data comprises first feedback data, and further comprising:
determining a price-matching quote including an indication of a lowest quote associated with the one or more users;
providing the price-matching quote to the second user;
receiving second feedback data from the second user indicating at least one of an acceptance or a denial of the price-matching quote; and
in response to receiving the second feedback data indicating an acceptance of the price-matching quote, providing the price-matching quote and the ranking to the first user.

20. The computer-implemented method of claim 19, wherein determining the cooperate quote is based at least in part on determining that the number of bidding rounds has been satisfied.
